(19) United States
(12) Patent Application Publication
(10) Pub. No.: US 2025/0224555 A1
(43) Pub. Date: Jul. 10, 2025

(54) FIBER OPTIC CABLE

(71) Applicant: NIPPON TELEGRAPH AND tELEPHONE CORPORATION, Tokyo (JP)

(72) Inventors: Masashi KIKUCHI, Musashino-shi (JP); Takayoshi MORI, Tokyo (JP); Yusuke YAMADA, Musashino-shi, Tokyo (JP)

(73) Assignee: NIPPON TELEGRAPH AND tELEPHONE CORPORATION, Tokyo (JP)

(21) Appl. No.: 18/880,534

(22) PCT Filed: Jul. 11, 2022
(86) PCT No.: PCT/JP2022/027258

§ 371 Date: Dec. 31, 2024

(51) Int. Cl. G02B 6/02; G02B 6/44

(52) U.S. Cl. CPC G02B 6/02095; G02B 6/02047; G02B 6/44384; G02B 2006/0209

(57) ABSTRACT

An object of the present disclosure is to enable LPG applied over the entire length of an optical fiber without inhibiting an operation of taking out the optical fiber.

The present disclosure relates to an optical fiber cable in which at least one or more optical fibers for transmission in at least two or more modes are gathered, the optical fiber cable including: a linear material abutting on at least one of the optical fibers, in which a thickness of the linear material periodically varies in a longitudinal direction of the linear material.

### TECHNICAL FIELD

The present disclosure relates to an optical fiber cable.

### BACKGROUND ART

In recent years, in an optical fiber communication system, a technique for getting different data transmittable in the respective modes, by using an optical fiber (hereinafter referred to as a few mode fiber (FMF)) capable of transmitting a plurality of modes through one core, to increase a transmission capacity has been studied (NPL 1).

Since each mode allowing propagation through the FMF has a different propagation constant except for a combination of some modes, a delay time at the time of transmission is different. Further, since the signals transmitted in the respective modes of the FMF are mixed in a reception unit, the mixed signals need to be restored independently by using a multi input multi output (hereinafter referred to as MIMO) technique (NPL 2). When the delay time at the time of transmission in each mode is different, mixed signals of a mode having the smallest delay time and a mode having the largest delay time are restored by using a digital signal processor (hereinafter referred to as DSP). Since a circuit scale of the digital signal processor increases as the difference in delay time between the modes increases, it is desirable to reduce the difference in delay time.

As a method for reducing the difference in delay time, a long-period optical fiber grating (hereinafter referred to as LPG) exists (NPL 3). The LPG applies a periodic lateral pressure to the optical fiber, and the refractive index of the optical fiber core periodically vary by virtue of the lateral pressure to promote coupling between modes. In particular, there is a method of providing a mode coupling unit for applying a periodic lateral pressure to the inside of an optical fiber cable with LPG applied over the entire length thereof (PTL 2). Embodiment 5 of this document describes an embodiment of a non-slot structure. In this embodiment, an unevenly textured sheet is incorporated to the cable such that the unevenness faces inward and is uniformly held to all the accommodated optical fibers.

### CITATION LIST

### Patent Literature

[PTL 1] JP 4774337 B2 (NTT)
[PTL 2] JP 2018-36339 A (NTT, JP 6581554 B2)

### Non Patent Literature

[NPL 1] D. Soma et al., “10.16 Peta-bit/s Dense SDM/WDM transmission over Low-DMD 6-Mode 19-Core Fibre Across C+L Band,” 2017 European Conference on Optical Communication (ECOC), 2017, pp. 1-3, doi: 10.1109/ECOC. 2017.8346082.
[NPL 2] P. J. Winzer, H. Chen, R. Ryf, K. Guan and S. Randel, “Mode-dependent loss, gain, and noise in MIMO-SDM systems,” 2014 The European Conference on Optical Communication (ECOC), 2014, pp. 1-3, doi: 10.1109/ECOC. 2014.6963888.
[NPL 3] H. Liu, H. Wen, R. Amezcua-Correa, P. Sillard and G. Li, “Reducing group delay spread in a 9-LP mode FMF using uniform long-period gratings,” 2017 Optical Fiber Communications Conference and Exhibition (OFC), 2017, pp. 1-3.

### SUMMARY OF INVENTION

### Technical Problem

However, in the structure described in PTL 2, when a large number of optical fiber cables are accommodated, the sheet needs to be made wide to be held to all the optical fibers. In addition, since the sheet houses all the optical fibers to be held thereto, connection with the optical fibers in the cable, due to the optical fibers covered with the sheet, has had a problem that the workability of taking out the optical fibers is greatly impaired. Therefore, there has been a demand for an optical fiber cable in which LPG is applied over the entire length and which enables a good operation of taking out optical fibers.

An object of the present disclosure is to enable LPG applied over the entire length of an optical fiber without inhibiting an operation of taking out the optical fiber.

### Solution to Problem

An optical fiber cable according to the present disclosure is: an optical fiber cable in which at least one or more optical fibers for transmission in at least two or more modes are gathered, the optical fiber cable including:
a linear material abutting on at least one of the optical fibers,
in which a thickness of the linear material periodically varies in a longitudinal direction of the linear material.

The linear material may be formed of at least two linear materials twisted together and integrated. In this regard, thicknesses of the at least two linear materials may be constant in the longitudinal direction. Further, tension may be applied to at least one linear material of the at least two linear materials, and tension may be applied to one linear material higher than tension is applied to any other linear material.

A position of the optical fiber may vary randomly in the longitudinal direction of the optical fiber cable. The linear material may function as a bundle tape which bundles at least one or more of the optical fibers. The linear material may be constituted by using yarn. For example, the linear material may have water absorbency.

The above disclosures can be combined as much as possible.

### Advantageous Effects of Invention

According to the present disclosure, an optical fiber cable capable of retaining a small-diameter structure, with LPG applied over the entire length, can be realized. Therefore, LPG can be applied over the entire length of the optical fiber of the present disclosure without hindering the operation of taking out the optical fiber.

### BRIEF DESCRIPTION OF DRAWINGS

FIG. 1 illustrates an example of a configuration of an optical fiber cable according to Embodiment 1: FIG. 1(a) indicates a side view and FIG. 1(b) indicates a cross-sectional view.

FIG. 2 illustrates an example of a shape of a linear material: FIG. 2(a) indicates a side view and FIG. 2(b) indicates a cross-sectional view.

FIG. 3 illustrates an example of the linear material of the present disclosure using a bundle tape.

FIG. 4 illustrates an example of a configuration of an optical fiber cable according to Embodiment 2: FIG. 4(a) indicates a side view and FIG. 4(b) indicates a cross-sectional view.

FIG. 5 illustrates an example of a configuration of an optical fiber cable according to Embodiment 3: FIG. 5(a) indicates a side view and FIG. 5(b) indicates a cross-sectional view.

### DESCRIPTION OF EMBODIMENTS

Embodiments of the present disclosure will be described hereinafter in detail with reference to the drawings. The present disclosure is understood not to be limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### Embodiment 1

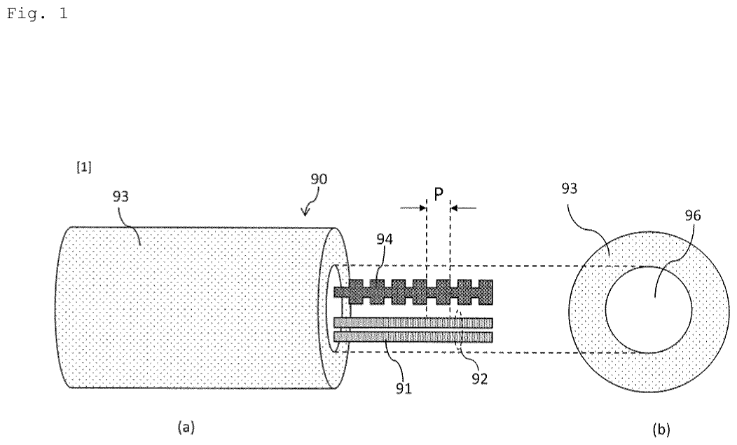

FIG. 1 illustrates a first embodiment of the present invention. An optical fiber cable 90 includes an optical fiber unit 92 including optical fibers 91 for transmission in at least two or more modes, in which at least one of the optical fibers 91 is gathered, and a sheath 93 that covers a periphery of the optical fiber unit 92. In this way, the optical fiber cable 90 has a non-slot structure that can be reduced in diameter and weight and eliminates slot rods (see, for example, PTL 1).

A cable core 96 of the optical fiber cable 90 is equipped with a linear material 94 assembled in the sheath 93 in a longitudinally attached or twisted manner to the optical fiber unit 92, and a thickness of the cross section of the linear material 94 is defined as t. The thickness t is determined by a length of a line segment crossing the cross section of the linear material 94, and periodically varies in a longitudinal direction of the linear material 94. The length of this line segment may be a maximum length in the cross section or may be an average length.

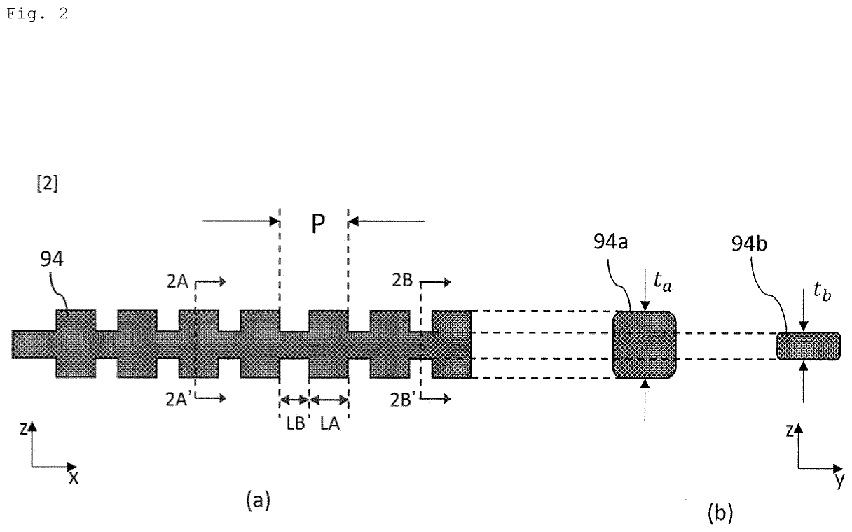

FIG. 2 illustrates an example of a shape of the linear material 94. In the linear material 94, a region L_{A} having a thickness t_{A} and a region L_{B} having a thickness t_{B} are alternately disposed in the longitudinal direction. 94a depicts a cross-sectional shape, with a thickness t_{A}, taken along a line 2A-2A′, and 94b depicts a cross-sectional shape, with a thickness t_{B}, taken along a line 2B-2B′. Thus, in this embodiment, the thickness of the linear material 94 periodically varies at a period P.

Although this embodiment illustrates an example in which the cross-sectional shapes 94a and 94b are rectangular, and the lengths of two opposite sides periodically vary, the present disclosure is not limited thereto. For example, the cross-sectional shapes 94a and 94b are rectangular and all sides may periodically vary. Further, the cross-sectional shape of the linear material 94 is not limited to a rectangular shape, but can be any shape capable of applying a lateral pressure to the optical fiber 91 such as a circular shape.

Here, it is desirable that the period of the thickness t be a value bringing about efficient coupling between the modes of the FMF. Assuming that the propagation constants of the FMF propagation modes are β_{L} and β_{M}, the period P of the thickness t bringing about the strongest mode coupling is expressed by Equation (1).

P=2π/(β_{L}−β_{M}) (1)

Then, by applying the lateral pressure to the optical fibers 91, using the variation between the cross-sectional shapes 94a and 94b, at the period P corresponding to β_{L} and β_{M} as the propagation constant of the optical fiber 91, coupling between modes of the FMF can be efficiently generated.

Since the linear material 94 is gathered in the optical fiber unit 92, it abuts on at least one of the optical fibers 91 included in the optical fiber unit 92. By periodically varying the thickness of the linear material 94 at the period P, the lateral pressure corresponding to the periodically varying thickness t can be applied to the optical fiber 91. In addition, since the linear material 94 does not cover the optical fiber unit 92, good workability for taking out the optical fiber 91 can be kept with respect to connection with the optical fiber cable 90.

When a plurality of optical fibers 91 are accommodated, it is desirable to apply periodic lateral pressure to all the optical fibers 91. When the lateral pressure, which periodically varies over the entire length, is applied to all the optical fibers 91, there are the following methods.
(i) One is a method of longitudinally attaching one linear material to one optical fiber.
(ii) Another is a method of forming an optical fiber tape by integrating a plurality of optical fibers, and longitudinally attaching the optical fiber tape by deforming the optical fiber tape to cover the periphery of the linear material, with respect to an optical fiber cable where a plurality of optical fibers are accommodated.

The position of the optical fiber 91, disposed on the cross section of the optical fiber cable 90 having the small diameter and high density structure, varies randomly in the longitudinal direction. Therefore, since the optical fibers 91 coming into contact with the linear material 94 are replaced depending on the position in the longitudinal direction, as a result, the periodically varying lateral pressure can be applied to all the optical fibers by the method (ii).

When the optical fiber cable 90 is damaged, the water entering from the damaged part propagates inside the optical fiber cable, and as a result, the water immersion range may extend over a long distance. As a countermeasure for this, a yarn for preventing water immersion may be applied. Here, the yarn is a string-like member formed by knitting fiber yarns, and in the optical fiber cable, the yarn is used as an interposition so that the cross-sectional shape of the cable core 96, including the optical fiber unit 92 and the linear material 94, approaches a circle, and the yarn is used to enhance the water-stopping performance of the optical fiber cable 90 by applying water-absorbing powder, for water-stopping, to the inside of the yarn. In this embodiment, the yarn may also serve as the linear material 94. In this regard, the linear material 94 may have any function that the yarn has, for example water absorption.

In addition, a colored bundle tape 95 for identifying the optical fiber unit 92 may be wound around the optical fiber unit 92. The bundle tape 95 may also serve as the linear material 94.

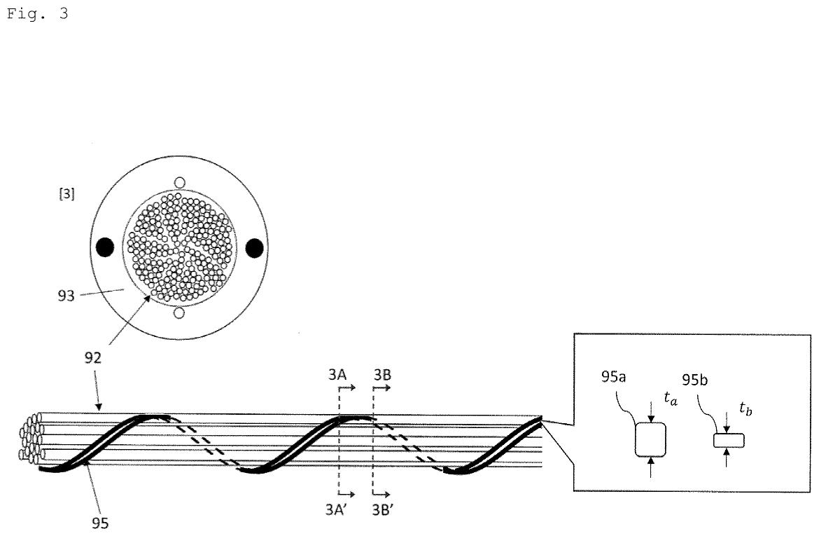

FIG. 3 illustrates an example of the bundle tape 95. In the drawing, 95a depicts a cross-sectional shape, with a thickness t_{A}, taken along a line 3A-3A′, and 95b depicts a cross-sectional shape, with a thickness t_{B}, taken along a line 3B-3B′. For example, in the bundle tape 95, like the linear material 94 shown in FIG. 2, a region L_{A} having a thickness t_{A} and a region L_{B} having a thickness t_{B} are disposed alternately. Thus, the thickness of the bundle tape 95 may periodically vary at the period P.

### Embodiment 2

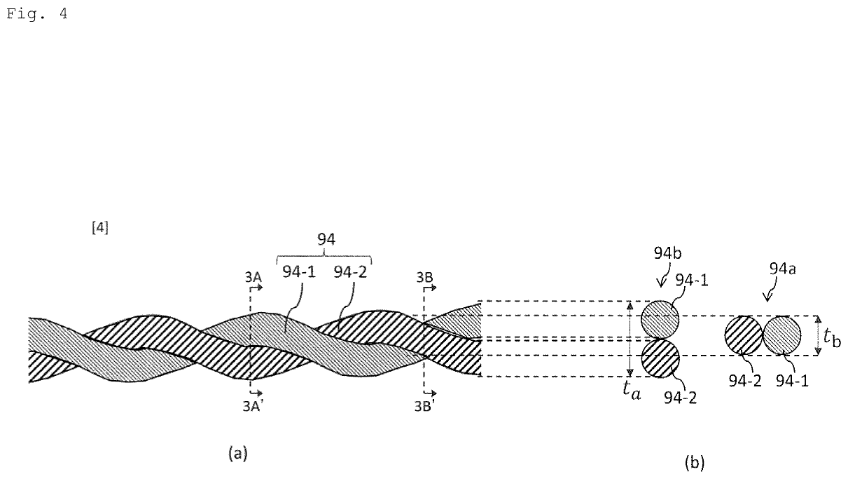

FIG. 4 is a configuration diagram of an optical fiber cable, illustrating a second embodiment of the present disclosure. The linear material 94 of Embodiment 1 is integrally formed by twisting two linear materials 94-1 and 94-2. 94a depicts a cross-sectional shape, with a thickness t_{A}, taken along a line 4A-4A′, and 94b depicts a cross-sectional shape, with a thickness t_{B}, taken along a line 4B-4B′. Regarding the linear material 94 of the present disclosure, the thickness of the linear material 94 may periodically vary by combining linear materials 94-1 and 94-2 having a constant cross-sectional shape.

With such a configuration, a spiral shape is formed on the surfaces of the twisted linear materials 94-1 and 94-2. Since the optical fiber 91 is brought into contact with the side face of the spiral in one direction, variation of a periodic lateral pressure to the optical fiber 91 is generated. Therefore, the same effect as that of Embodiment 1 can be achieved.

In addition, the spiral shape can have any period P of variation of the lateral pressure, by changing each thickness of the linear materials 94-1 and 94-2 to be twisted together and the number of revolutions for twisting together.

Further, the cross-sectional shapes of the linear materials 94-1 and 94-2 may be the same, and may be constant in the longitudinal direction. Therefore, in this embodiment, the optical fiber cable according to the Embodiment 1 in which the period of the thickness t is set to a desired value can be realized only by one kind of linear material.

### Embodiment 3

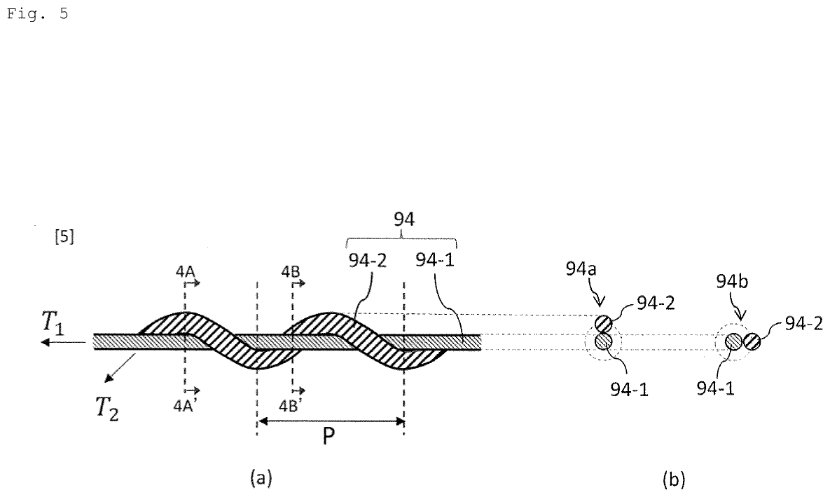

FIG. 5 is a structural diagram of an optical fiber cable, illustrating a third embodiment of the present disclosure. In the configuration of Embodiments 1 to 2, in order to make the magnitude of the periodic lateral pressure sufficient, it is necessary to increase an accommodation density (a ratio of the cross-sectional area occupied by the optical fiber unit 92 and the linear material 94, accommodated in the cable core, to the cross-sectional area of the cable core 96). However, when the accommodation density is increased, there is a problem that the loss, which arise from making a cable with the optical fiber 91, tends to increase.

In this embodiment, tension T₁ of one linear material 94-1, among the linear materials 94-1 and 94-2, higher than tension T₂ of the other linear material 94-2 is implemented in the structure of Embodiment 2.

With such a constitution, the linear material 94-1 having higher tension takes a linear shape, and the periphery thereof is covered with the other linear material 94-2 in a spiral shape. Therefore, a large lateral pressure can be obtained even when the number of the linear materials 94-1 and 94-2 is the same as that of the structure of Embodiment 2: the linear material 94-2 is held to the optical fiber 91 windingly. In other words, the desired periodic lateral pressure can be realized, while the ratio of a possession of the linear material 94 to the cross-sectional area of the inside of the optical fiber cable 90 is kept small.

### REFERENCE SIGNS LIST

91 Optical fiber
92 Optical fiber unit
93 Sheath
94, 94-1, 94-2 Linear material
95 Bundle tape
96 Cable core

1. An optical fiber cable in which at least one or more optical fibers for transmission in at least two or more modes are gathered, the optical fiber cable comprising:
a linear material abutting on at least one of the optical fibers,
wherein a thickness of the linear material periodically varies in a longitudinal direction of the linear material.

2. The optical fiber cable according to claim 1,
wherein the linear material is formed of at least two linear materials twisted together and integrated.

3. The optical fiber cable according to claim 2,
wherein tension is applied to at least one linear material of the at least two linear materials, and tension is applied to one linear material higher than tension is applied to any other linear material.

4. The optical fiber cable according to claim 2,
wherein thicknesses of the at least two linear materials are constant in the longitudinal direction.

5. The optical fiber cable according to claim 1,
wherein a position of the optical fiber varies randomly in the longitudinal direction of the optical fiber cable.

6. The optical fiber cable according to claim 1,
wherein the linear material functions as a bundle tape which bundles at least one or more of the optical fibers.

7. The optical fiber cable according to claim 1, wherein the linear material has water absorbency.
